(19) United States
(12) Patent Application Publication
(10) Pub. No.: US 2015/0261238 A1
(43) Pub. Date: Sep. 17, 2015

(54) SYSTEM FOR DETECTING USER BEHAVIOR WITHOUT USING EXTERNAL ELECTRIC POWER

(71) Applicant: National Taiwan University, Taipei (TW)

(72) Inventors: CHUN-TING CHOU, Taipei City (TW); YU-JEN KU, Hsinchu County (TW); CHUN-YU CHEN, Tainan City (TW)

(73) Assignee: National Taiwan University, Taipei (TW)

(21) Appl. No.: 14/464,693

(22) Filed: Aug. 20, 2014

(30) Foreign Application Priority Data
Mar. 11, 2014 (TW) 103108356

(51) Int. Cl. G05F 1/66

(52) U.S. Cl. CPC G05F 1/66

(57) ABSTRACT

The system, which detects a user behavior without using, an external electric power, transmits a signal according to the user behavior by an energy generated according to the user behavior. The system includes an energy conversion device and a signal transmitting device. The energy conversion device is disposed on an object. When the user uses the object, the energy conversion device converts the energy, which is directly or indirectly generated by the user behavior, into electrical energy. The signal transmitting device is electrically connected to the energy conversion device and transmits a notification signal by electrical energy generated from the energy conversion device. The energy includes the mechanical energy, the thermal energy and the electromagnetic energy. When the user uses the object, the energy is converted into electrical energy, which is then provided to the signal transmitting device for transmitting the notification signal.

### BACKGROUND OF THE INVENTION

1. Field of the Invention

The present invention generally relates to a system for detecting user behavior, and more particularly to a system for detecting user behavior without using external electric power.

2. Description of Related Art

At present, there is a lot of equipment or devices with detecting and monitoring functions on the market for purposes of the management, the notification or the record. However, these detecting or monitoring devices are usually electronic devices, which need to take extra electric power to operate. Therefore, it would cause the inconvenience and increase the cost, when the electric power runs out or a need for the electric power to replace occurs. Furthermore, the conventional devices are not able to perform detecting and monitoring functions, while the user is replacing the electric power for the devices. Although the solar panel could be used as a substitute power supply, however it wouldn't work when there is no sun lights (e.g., indoor or at night). Besides, while using some electronic devices (such as cameras) for detecting and monitoring purposes, it would also probably infringing user's personal privacy.

A need has thus arisen to propose a system for achieving the detecting and monitoring purposes without periodically replacing the battery while protecting the user's personal privacy and simultaneously.

### SUMMARY OF THE INVENTION

In view of the foregoing, the present invention provides a system for detecting user behavior without using an external electric power. The system includes an energy conversion device and a signal transmitting device. The energy conversion device disposed on an object. When the user uses the object, the energy conversion device directly or indirectly converts the energy generated from the user behaviors into an electrical energy. The signal transmitting device is electrically connected to the energy conversion device, and the signal transmitting device transmits the notification signal by electrical energy generated from the energy conversion device.

The energy, which is generated from the user behavior for using the objects in the present invention, includes the mechanical energy, the heat energy, the electromagnetic energy and others. When the user is using the object, the direct or indirect energy that mentioned above will be transformed into the electronic energy by the energy conversion device, and then the electrical energy will be supplied to the signal transmitting device as a power source, so as to transmit the notification signal.

In view of the foregoing, with the use of the system for detecting user behavior without using an external electric power in the present invention, it not only can achieve the effects for detecting, notifying and monitoring, but also can improve the maintenance and replacement of the general electronic monitoring devices which must be used with an external power supply. Furthermore, the system for detecting user behavior without using an external electric power in the present invention detects, monitors and notifies the status of user in using the object, so that personal privacy of the user (such as his/her video image or voice) may be well protected.

### BRIEF DESCRIPTION OF THE DRAWINGS

FIG. 1 illustrates a system 1 for detecting user behavior without external power according to an embodiment of present invention;

FIG. 2A illustrates a view of the user using a pushing door according to an embodiment of present invention;

FIG. 2B illustrates a view of the user using a door knob according to an embodiment of present invention;

FIG. 3 illustrates a view of the user using a fan according to an embodiment of present invention;

FIG. 4 illustrates a view of the user using a toilet according to an embodiment of present invention;

FIG. 5 illustrates a view of the user using a gas stove according to an embodiment of present invention;

FIG. 6A illustrates a decomposed view of the user using a water faucet according to an embodiment of present invention;

FIG. 6B illustrates a composed view of the user using a water faucet according to an embodiment of present invention;

FIG. 7 illustrates a view of the user using a window according to an embodiment of present invention;

FIG. 8 illustrates a view of the user using a toothbrush according to an embodiment of present invention;

FIG. 9 illustrates a view of the user using a drawer according to an embodiment of present invention;

FIG. 10A illustrates a view of the magnetic objects being arranged linearly according to an embodiment of present invention;

FIG. 10B illustrates a view of the magnetic objects being arranged circularly according to an embodiment of present invention;

FIG. 11 illustrates a view of magnetic objects being circularly arranged on a door frame according to an embodiment of present invention;

FIG. 12A illustrates a system for detecting a user being using a varying magnetic field generator object according to an embodiment of present invention;

FIG. 12B illustrates a view of the user using the system for detecting a user being using a varying magnetic field generator object according to an embodiment of present invention;

FIG. 13A illustrates a system for detecting a user being using a heat generating object; and

FIG. 13B illustrates a view of the user using heat generating object, according to an embodiment of the present invention.

### DETAILED DESCRIPTION OF THE INVENTION

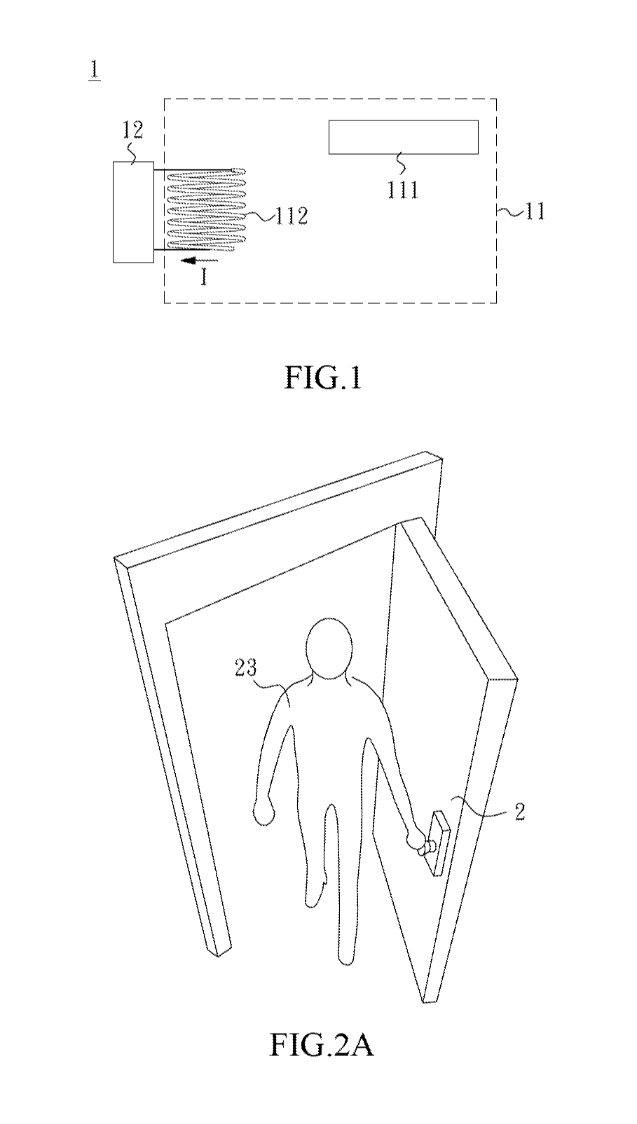

Referring to FIG. 1, FIG. 1 illustrates a system 1 for detecting user behavior without external power according to an embodiment of the present invention. The system 1 includes an energy conversion device 11 and a signal transmitting device 12. The energy conversion device 11 is disposed on an object or close to the object (not illustrated). When a user uses the object, the energy conversion device 11 will directly or indirectly transform the energy, which is generated from the user behaviors, into an electrical energy for activating the signal transmitting device 12. The signal transmitting device 12 is electrically connected to the energy conversion device 11, so that the signal transmitting device 12 may transmit a notification signal to a receiving device (not illustrated) by the electrical energy generated from the energy conversion device 11. Therefore, a supervisor may determine the status of the user in using the object according to the notification signal, so as to detect the user behavior.

In order to solve the problem caused by conventional detecting devices with the external energy, the system for detecting user behavior without using an external electric power in the present invention is based on the principle of detecting the status of the object. More particularly, the system generates energy by the change of the status of the object, while the user uses the object. Then, the energy is used to generate a signal, and the signal is transmitted to other receiving devices for the detecting, monitoring and notifying purposes. In the embodiment of the present invention, the energy, which is generated from the user behaviors in using the object, includes the mechanical energy, the heat energy, the electromagnetic energy, and others.

Furthermore, for the purpose of converting the energy, the energy conversion device 11 of the present invention includes a mechanical energy conversion device, an electromagnetic energy conversion device and/or a thermoelectric power generating device. The mechanical energy conversion device includes at least one magnetic object 111 and an inductive coil 112. The inductive coil 112 is disposed corresponding to the magnetic object 111 and electrically connected to the signal transmitting device 12. The inductive coil 112 generates an induced current I with respect to the movement of the magnetic object 111. Then the induced current flows to the signal transmitting device 12, so that the signal transmitting device 12. can generate a notification signal according to the induced current I, and the notification signal will be transmitted to the signal receiving device. Thus, the supervisor may detect the status of the object according to the notification signal, so as to determine the user behavior.

In one embodiment of the present invention, the signal transmitting device 12 includes a signal transmitting chip, and the magnetic object 111 may be, for example, at least one magnet.

In the embodiment of the present invention, the objects are distinguished into the rotatable object and the movable object. The rotatable object includes a door knob of a pushing door, a flushing switch of a toilet, a rotary switch of a gas stove, a turbine blade of a water faucet, and so on. The movable object includes a pushing door, a window, a drawer, a toothbrush and so on.

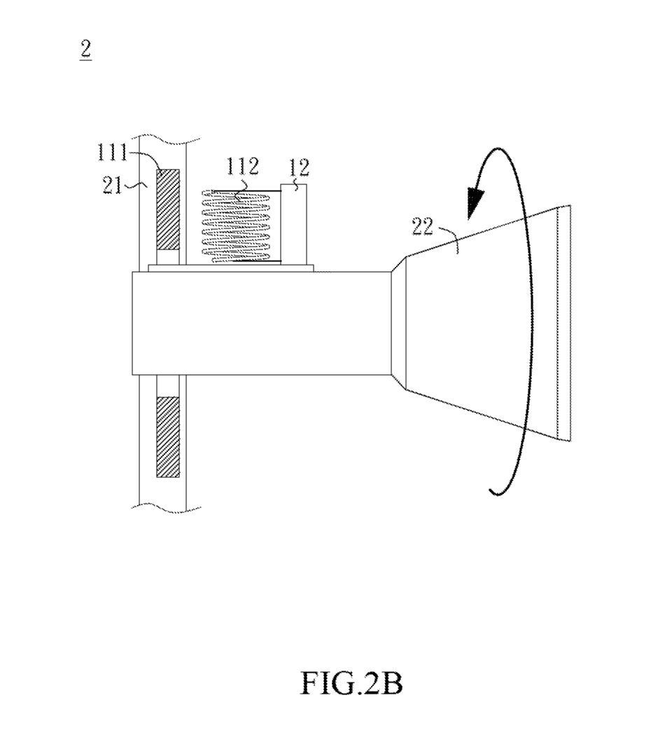

Referring to FIG. 2A and FIG. 2B, FIG. 2A and FIG. 2B respectively illustrate the views of the user opening a door 2 according to an embodiment of the present invention. In this embodiment, the magnetic object 111 is disposed on the pushing door 21, and the inductive coil 112 is disposed on the door knob 22. Therefore, when the user 23 rotates the door knob 22, the inductive coil 112 disposed on the door knob 22 will generate an induced current, which is corresponding to the relative rotation of the magnetic object 111 disposed on the pushing door 21. The signal transmitting chip generates a notification signal according to the induced current, and the notification signal is then transmitted to the receiving device. Thus, the system 1 may detect that the user 23 has activated the pushing door 21, according to the notification signal. In addition, in the embodiment of the present invention, the magnetic object and inductive coil are not limited to be disposed on the certain positions that this embodiment has illustrated, and the magnetic object and inductive coil may also be disposed on the positions were the inductive coil may sense the relative movements with respect to the magnetic object so as to generate the induced current.

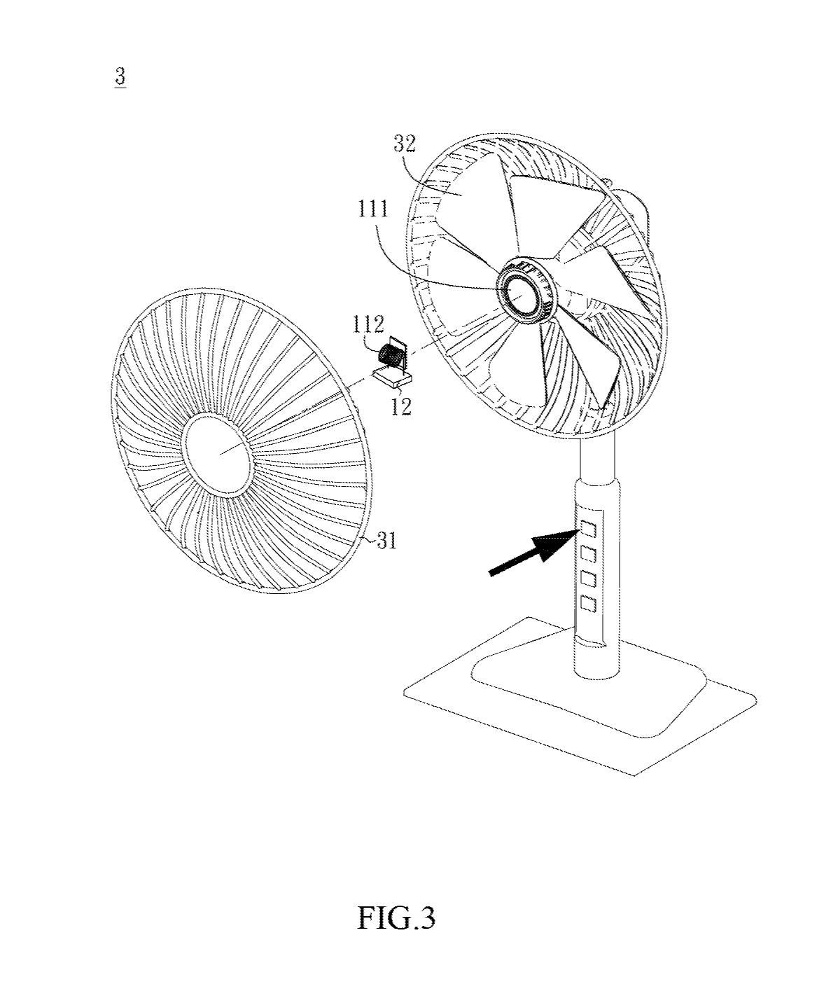

FIG. 3 illustrates the view of the user using, a fan 2 according to an embodiment of the present invention. In this embodiment and the following embodiments, for the simplicity, the direction of the arrow is illustrated as the movement direction of the user using, the object. The inductive coil 112 is disposed on an outer frame 31 of the fan 3, and the magnetic object 111 is disposed on a fan blade 32 of the fan 3. Thus, when the user presses a power switch of the fan 3 (as shown by the arrow), the magnetic object 111 disposed on the fan blade 32 may rotate with respect to the inductive coil 112 disposed on the fan outer frame 31, so as to generate an induced current. Then, the signal transmitting chip may generate a notification signal according to the induced current, and the notification signal is transmitted to the other electronic devices. Thus, the system 1 may detect that the user has activated the fan 3, according to the notification signal.

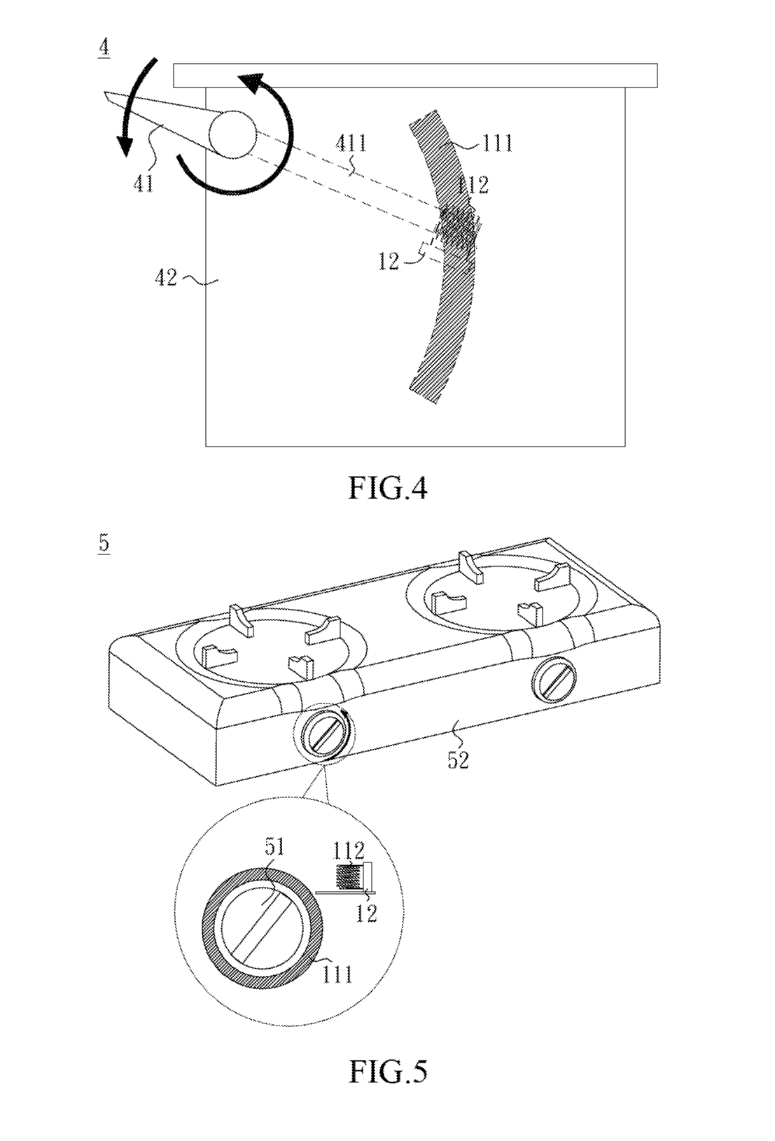

FIG. 4 illustrates a view of the user using a toilet 4 according to an embodiment of the present invention. In this embodiment, the inductive coil 112 is disposed on a handle 411 of a flushing switch 41, and a magnetic object 111 is disposed on a casing 42 of the toilet 4. Thus, when the user presses the flushing switch 41 of the toilet 4, the magnetic object 111, which is disposed on the toilet casing 42, will rotate with respect to the inductive coil 112, which is disposed on the handle 411 of the flushing switch 41, so as to generate an induced current. The signal transmitting chip may generate a notification signal according to the induced current, and the notification signal is then transmitted to the other electronic devices. Thus, the system 1 may detect that the user is using the toilet 4, according to the notification signal.

FIG. 5 illustrates a view of the user using a gas stove 5 according to an embodiment of the present invention. In this embodiment, a magnetic object 111 is disposed on a rotary switch 51 of the gas stove 5, and an inductive coil 112 is disposed on a main body 52 of the gas stove 5. Therefore, when the user activates the rotary switch 51 of the gas stove 5, the magnetic object 111, which is disposed on the rotary switch 51, may rotate with respect to the inductive coil 112 of the gas stove main body 52, so as to generate an induced current. The signal transmitting chip may generate a notification signal according to the induced current, and the notification signal is then transmitted to the receiving device. Thus, the system 1 may detect that the user has activated the gas stove 5, according to the notification signal.

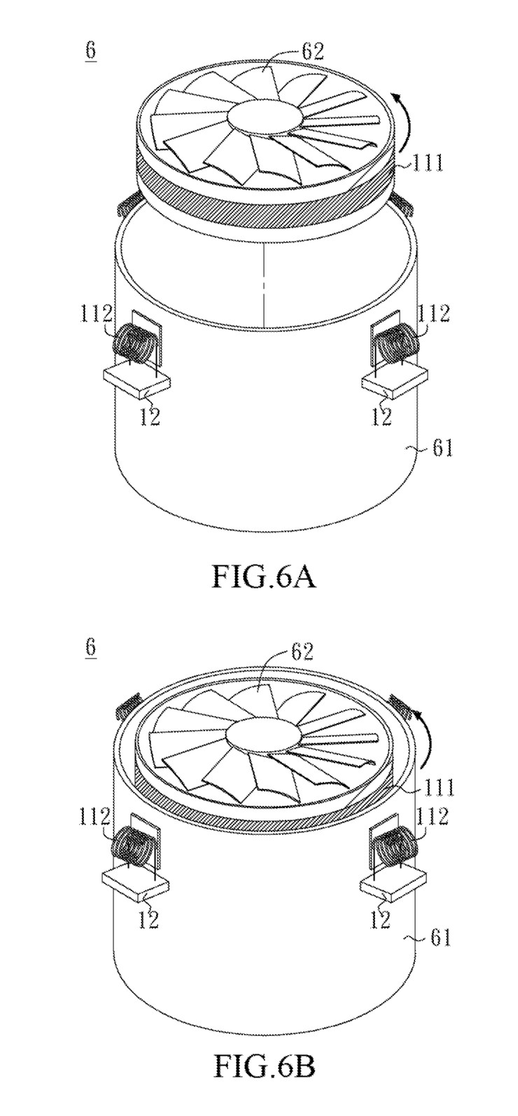

Referring to FIG. 6A and FIG. 6B, FIG. 6A and FIG. 6B respectively illustrate a decomposed view and a composed view of a water faucet 6, according to an embodiment of the present invention. In this embodiment, for simplicity, a switch of the water faucet 6 is not illustrated, and only the structure of an inner part of the water faucet 6 is illustrated. Besides, the embodiment is similar to the other embodiments of the present invention, but the difference is that the system 1 of this embodiment can detect a signal that indicates the mechanical energy transformed by water. Therefore, the turbine blade 62, which is disposed in the water pipe 61 of the water faucet 6, is configured to detect a signal that indicates whether water flows in the water faucet 6 or not. The inductive coil 112 is disposed on an external side of the water pipe 61 of the water faucet 6, and the magnetic object 111 is disposed on an external side of the turbine blade 62. Thus, when user activates the switch of the water faucet, the water will flow through the turbine blade 62, so that the magnetic object 111 disposed on the turbine blade 62 may rotates with respect to the inductive coil 112 disposed on the external side of the water pipe 61, in order to generate an induced current. The signal transmitting chip may generate a notification signal according to the induced current, and the notification signal is then transmitted to the receiving device. Thus, system 1 may detect that the user has turned on the water faucet according to the notification signal.

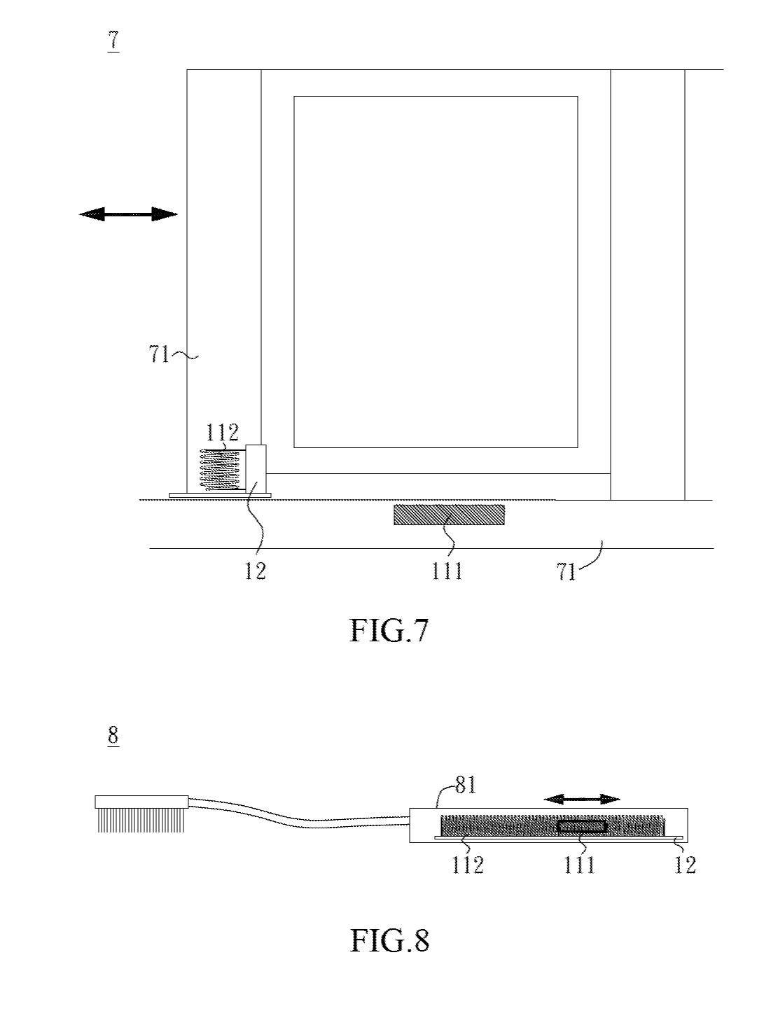

FIG. 7 illustrates a view of the user operating a window 7 according to an embodiment of the present invention. In this embodiment, an inductive coil 112 is disposed on the window 7, and a magnetic object 111 is disposed on a door frame 71 of the window 7. Thus, when the user opens the window 7, the inductive coil 112 disposed on the window 7 may make a movement with respect to the magnetic object 111 disposed on the door frame 71 of the window 7, so as to generate an induced current. The signal transmitting chip may generate a notification signal according to the induced current, and the notification signal is then transmitted to the receiving device. Thus, the system I may detect that the user has opened the window, according to the notification signal.

FIG. 8 illustrates a view of the user using a toothbrush 8 according to an embodiment of the present invention. In this embodiment, the inductive coil 112 may be disposed in a main body 81 of the toothbrush or coated on the on an external part of the main body 81, and the magnetic object 111 is disposed in the main body 81 of the toothbrush, so that the magnetic object 111 may move in the main body 81 in the toothbrush. Besides, it should be noted that FIG. 8 illustrates the view of the inductive coil 112 being disposed in the main body 81 of the toothbrush and coated on the magnetic object 111. Thus, when the user uses the toothbrush 8, the magnetic object 111 disposed in the toothbrush 8 may correspondingly generate an induced current according to the relative movement of the inductive coil 112. The signal transmitting chip may generate a notification signal according to the induced current, and then transmit the notification signal to the receiving device. Accordingly, the system 1 may detect that the user is using the toothbrush and determine how long, he/she is using the toothbrush, according to the notification signal.

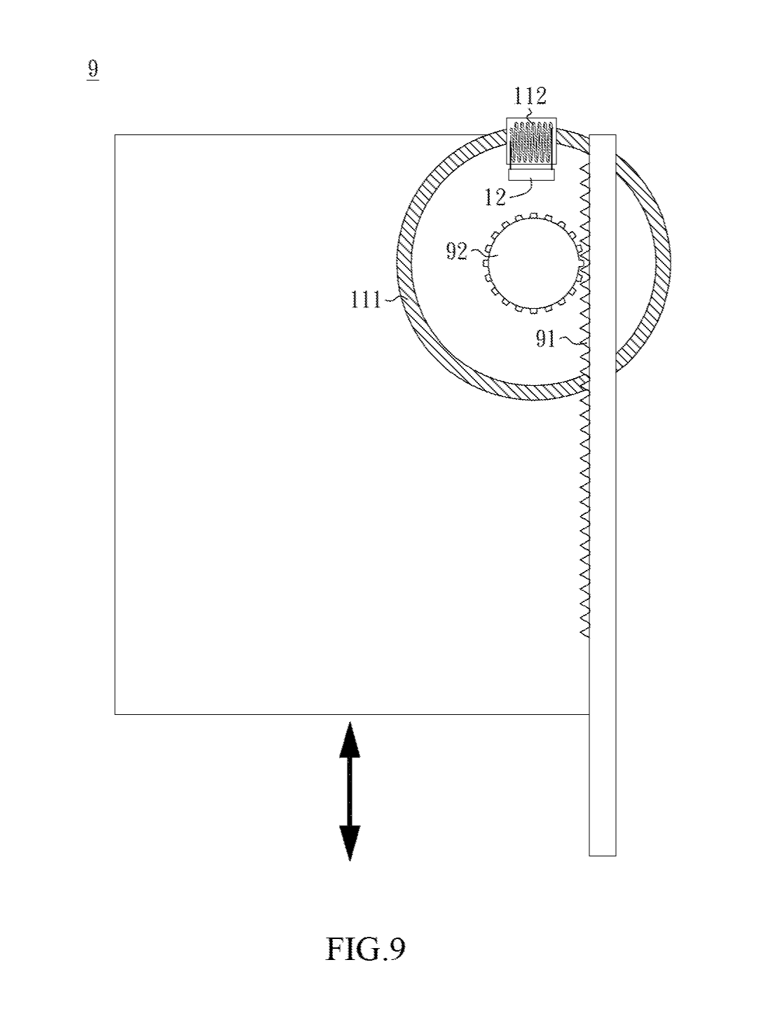

FIG. 9 illustrates a view of the user using a drawer 9 according to an embodiment of the present invention. This embodiment basically is similar to the other embodiments, and the main difference is that the drawer 9 of this embodiment includes a sliding rail 91 and a mesh gear 92. The mesh gear 92 is meshed with the sliding rail 91, and the magnetic object 111 is disposed on a main body of the mesh gear 92, and the inductive coil 112 is disposed with respect to the magnetic object 111. When the user opens the drawer 9, the magnetic object 111 disposed on the main body of the mesh gear 92 may generate an induced current with respect to the relative rotations of the inductive coil 112. The signal transmitting chip generates a notification signal according to the induced current, and then the notification signal is transmitted to the receiving device. Thus, the system 1 may detect that the uses has opened the drawer according to the notification signal.

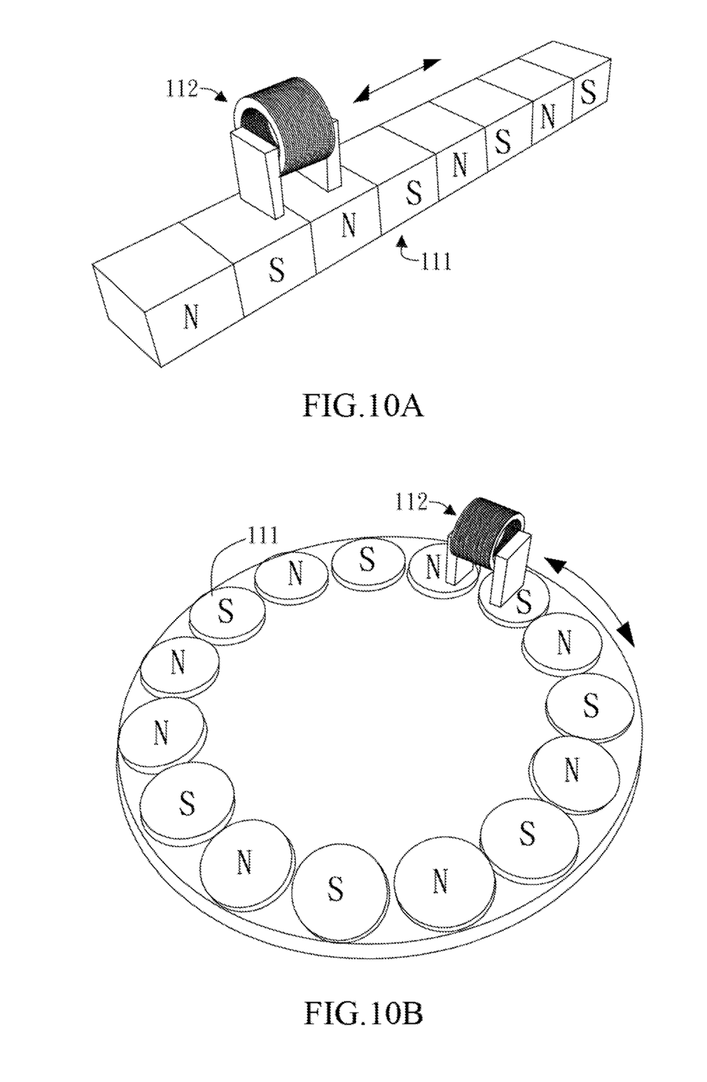

Referring to FIG. 10A and FIG. 10B, FIG. 10A and FIG. 10B respectively illustrate that magnetic objects are arranged linearly and circularly. In the above system 1 of the present invention, the magnetic objects 111 in the mechanical energy conversion device may for example be arranged linearly or circularly as the arrangements as FIG. 10A or FIG. 10B. The arrangement of the magnetic objects 111 may be as same as FIG. 10A or FIG. 10B which illustrated the S pole and N pole of the magnets being transversely arranged, but not limited thereto.

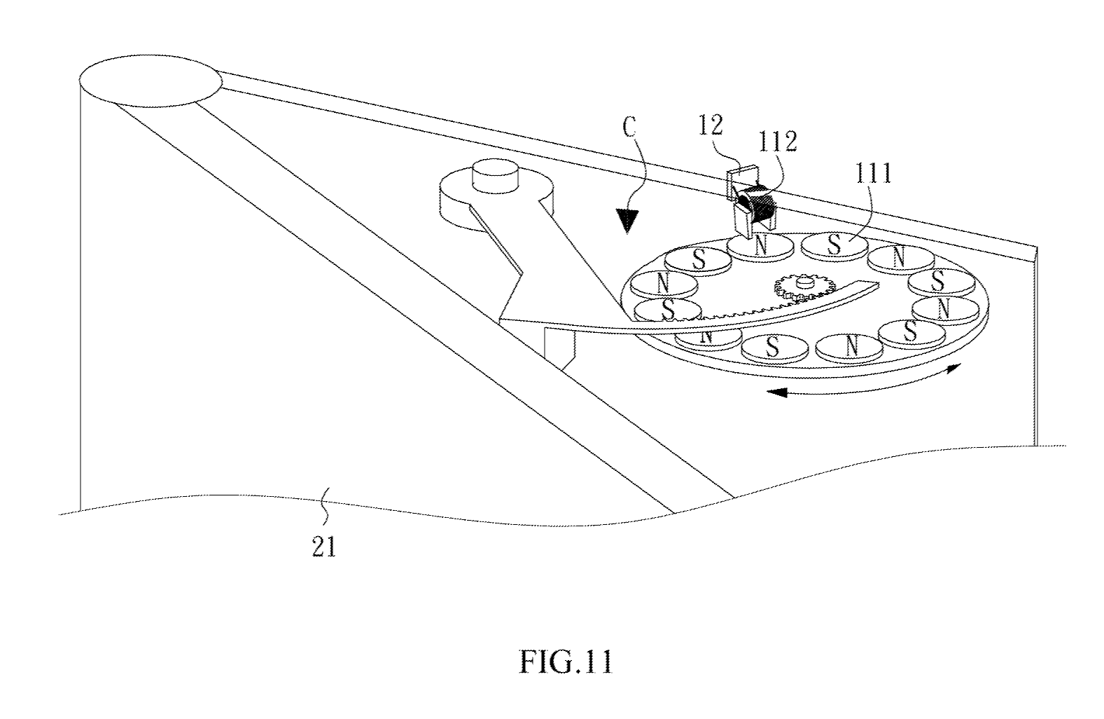

Referring to FIG. 11, FIG. 11 illustrates a view of magnetic objects 111 being circularly arranged on a door frame according to an embodiment of the present invention. According to what has been mentioned above, in the embodiment of the present invention, the system may determine the status of the user in using the object according to the notification signal, so as to detect that the user 23 has opened the pushing door 21.

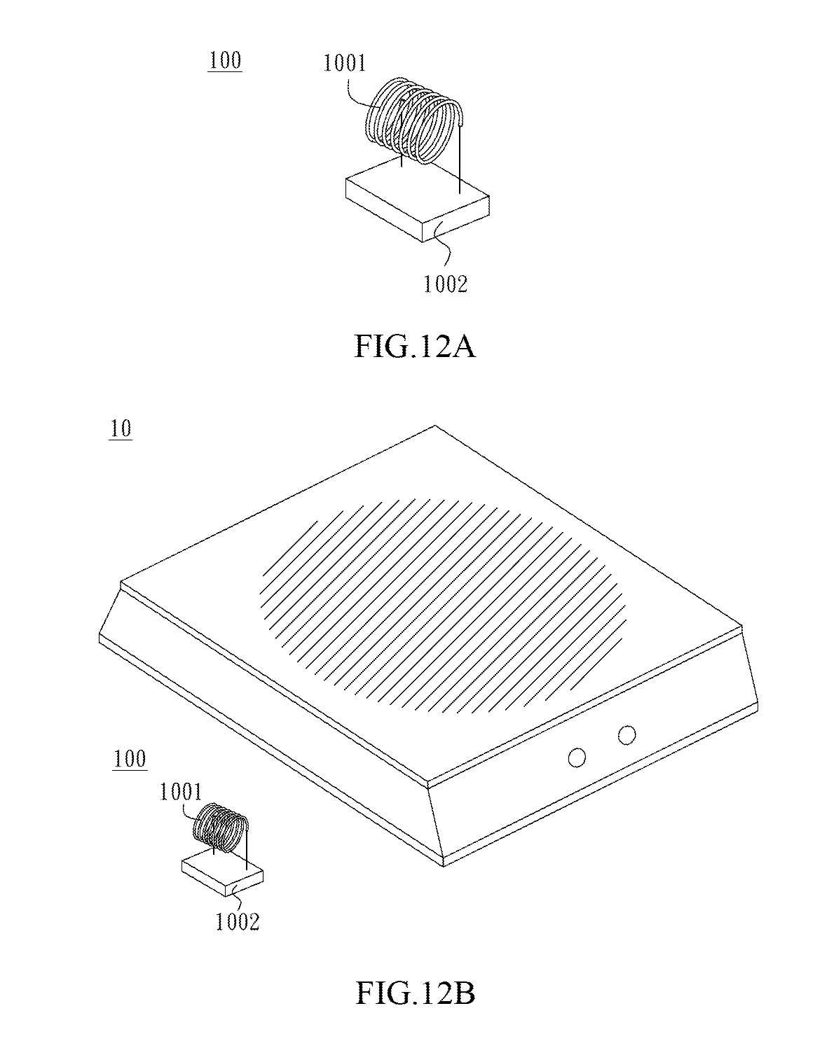

Referring to FIG. 12A, FIG. 12A illustrates a system 100 for detecting a user being using a varying magnetic field generator object, according to an embodiment of the present invention. The system 100 includes an electromagnetic energy conversion device 1001 and a signal transmitting device 1002.

The electromagnetic energy conversion device 1001 is disposed close to a varying magnetic field generator object. When the user use the varying magnetic field generator object, electrical energy may be generated on the basis of the electromagnetic induction principle. The signal transmitting device 1002 is electrically connected to the electromagnetic energy conversion device 1001, and the signal transmitting device 1002 transmits the notification signal by the electrical energy, which is generated by the electromagnetic energy conversion device.

Referring to FIG. 12B, FIG. 12B illustrates a view of the user using the system 100 for detecting a user being using a varying magnetic field generator object, according to an embodiment of the present invention. The varying magnetic field generator object includes an induction cooker and the others. In this embodiment, the detection of the magnetic field in an induction cooker 10 is illustrated as an example. The electromagnetic energy conversion device 1001 includes an inductive coil 1001, which is configured to sense a change of magnetic field of the induction cooker 10. When the user uses the object to cause a change of magnetic field in the varying magnetic field generator object, (that is to say, the induction cooker 10 is activated in this embodiment), the inductive coil 1001 may correspondingly generate an induced current. Thus, the signal transmitting device 1002 can generate a notification signal by the electrical energy generated from the electromagnetic energy conversion device 1001, and the notification signal is then transmitted to the receiving device. Accordingly, the supervisor may detect the use behaviors (e.g., cooking) according to the notification signal. In one embodiment of the present invention the signal transmitting device 1002 includes a signal transmitting chip.

Besides, when using, the object as induction cooker 10, which can continually cause changes of the magnetic field, the electromagnetic energy conversion device 1001 therefore may continue to generate the electrical energy. Transmitting the notification signals continually by the signal transmitting device 1002, the system may detect that the user is continually using the induction cooker 10.

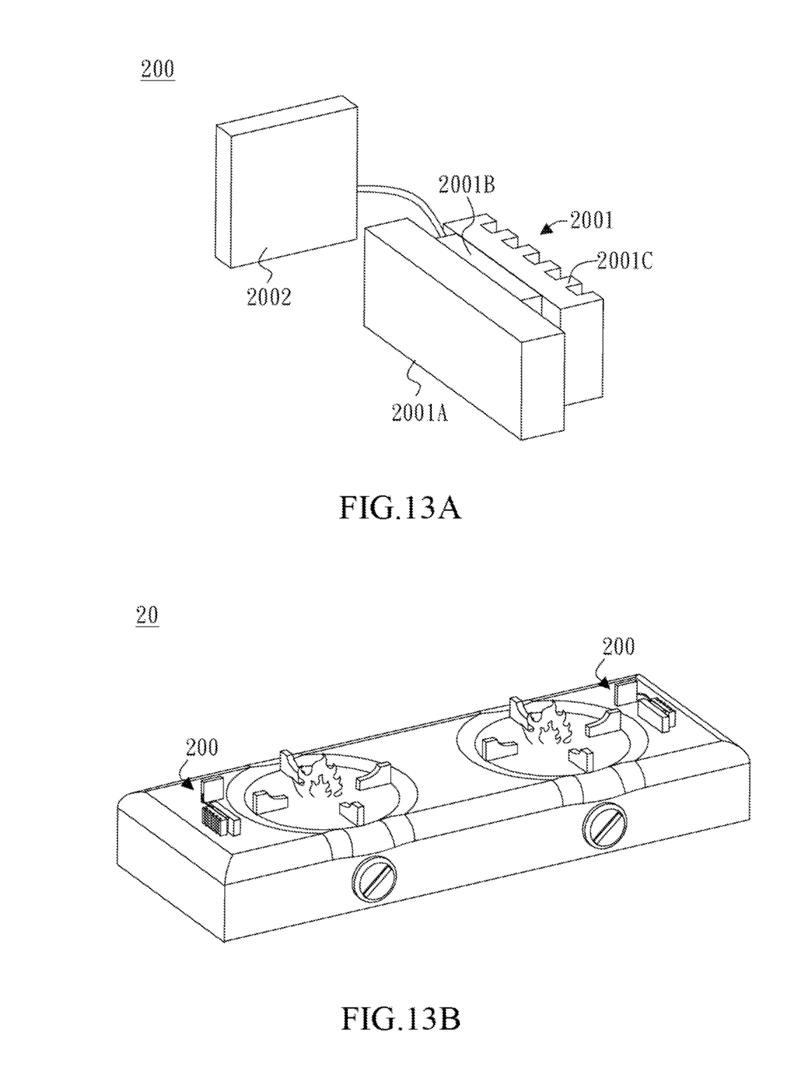

Referring to FIG. 13A, FIG. 13A illustrates a system 200 for detecting a user being using a heat generating object, according to an embodiment of the present invention. The system 200 includes a thermoelectric power generating device 2001 and a signal transmitting device 2002. The thermoelectric power generating device 2001 is disposed close to the heat generating object. When the user uses the heat generating object, thermoelectric power generating device 2001 may correspondingly generate an electrical energy. The signal transmitting device 2002 is electrically connected thermoelectric power generating device 2001, and the signal transmitting device 2002 transmits the notification signal by the electrical energy generated from the thermoelectric power generating device 2001. In this embodiment, the heat source includes the fire source which may cause temperature difference to the surrounding objects. That is to say, when there is a temperature difference between the temperature around the heat source and the ambient temperature, the system of the present invention may detect the temperature difference.

Referring to FIG. 13B, FIG. 13B illustrates a view of the user using heat generating object, according to an embodiment of the present invention. In this embodiment, a gas stove 20 is illustrated as an example for the heat generating object, and other objects, which can generate the heat source, may also be detected. The thermoelectric power generating device 2001 includes a thermal conduction module 2001A and a thermoelectric power generation chip 2001B. The thermal conduction module 2001A absorbs a heat energy generated from the heat generating object and then conducts the heat energy. The thermoelectric power generation chip 2001B is electrically connected to the signal transmitting device 2002, and the thermoelectric power generation chip 2001B generates an electrical energy by a temperature difference between a first surface and a second surface of the thermoelectric power generation chip 2001B. Furthermore, when the user uses the heat generating object, so as to cause a change of heat energy of the heat generating object, (that is to say, the gas stove 20 is activated in this embodiment), the thermal conduction module 2001A will absorb the heat energy generated from the gas stove 20, and the heat energy will then be conducted to the thermoelectric power generation chip 2001B. Thus, thermoelectric power generation chip 2001B may generate the electrical energy by the temperature difference between the first surface and second surface of the thermoelectric power generation chip 2001B. Accordingly, the electrical energy generated from the thermoelectric power generation chip 2001B is transmitted to the signal transmitting device 2002 in order to send the notification signal, and the notification signal may be received by the receiving device. According what has been mentioned above, the supervisor may detect the user behavior and know how long his/her behavior lasts (e.g., how long he/she is cooking) according to the notification signal. In one embodiment of the present invention, the signal transmitting device 2002 includes a signal transmitting chip. Besides, the thermoelectric power generating device 2001 further includes a heat dissipation plate 2001C, which is configured to cause a temperature difference between two opposite surfaces of the thermoelectric power generation chip 2001B. The thermoelectric power generation chip 2001B is disposed between the thermal conduction module 2001A and the heat dissipation plate 2001C.

In view of the foregoing, for the user, as the system detects or monitors the status of the object, but not directly records the images of the user's actions, to transmit the notification signal, it can protect user's personal privacy. For example, it may achieve the detecting, monitoring and notifying effects without the image devices such as cameras. Furthermore, it should be noted that all objects in the embodiment of the present invention are respectively configured to have a signal transmitting device, so the supervisor may determine which object has sent the notification signal. In other words, the supervisor can determine the user behaviors, according to the notification signal from the objects and the time intervals in the above embodiments of the present invention. For example, if medical drugs are placed in the drawer, then the supervisor can determine whether or not the drawer is opened according to the notification signal from the drawer, and the supervisor may also determine whether the elderly has taken the medicine with water, according to the notification signal from water fountains. Moreover, the supervisor can know the user's identity and determine whether the user's lifestyle is normal or not, according to the notification signal from the toothbrush and toilet. Furthermore, if the system receives the notification signal of the user opening the wardrobe, and then receives the notification signal of user opening the bathroom sliding door and the bathroom showers, the system can determine that the user may be in a status of taking a shower by the notification signals and the time intervals thereof.

Besides, for the hotel that greatly emphasizing the personal privacy, the status of the object may he detected and monitored, so as to figure out if there is an abnormal condition for the user (guest) in using the object. For example, if the system does not receive any signals at all (that is to say, no notification signal from the electrical object or non-electrical object is generated) after the guest enters to the hotel room, then the supervisor (the hotel operator) can determine that an accident may occur to the user, without infringing user's personal privacy. The similar application can be used in the case of monitoring elderly at home. Furthermore, in addition to the above embodiments of the present invention and the combination thereof, any other detecting systems without using external energy, that are able to be disposed on other objects, can be used in detecting the status of user in using the object, and also transmitting the notification signal.

In view of the foregoing, with the use of the system detecting user behavior without using an external electric power in the present invention, it not only can achieve the effects for detecting, notifying and monitoring, but also can improve the maintenance and replacement of the general electronic monitoring devices which must be used with an external power supply. Furthermore, the system detecting user behavior without using an external electric power in the present invention detects, monitors and notifies the status of user in using the object, so that personal privacy of the user may be well protected.

What is claimed is:

1. A system for detecting user behavior without using an external electric power, comprising:
an energy conversion device, disposed on an object, wherein when a user uses the object, the energy conversion device generates an electrical energy; and
a signal transmitting device, electrically connected to the energy conversion device, and the signal transmitting device transmits a notification signal by the electrical energy generated from the energy conversion device.

2. The system of claim 1, wherein the object includes a rotatable object, a movable object, a heat generating object or a varying magnetic field generator object.

3. The system of claim 2, wherein the rotatable object includes a door knob of a pushing door, a fan blade of a fan, a flushing switch of a toilet, a rotary switch of a gas stove or a turbine blade of a water faucet.

4. The system of claim 2, wherein the movable object includes a window, a drawer or a toothbrush.

5. The system of claim 1, wherein the energy conversion device comprises:
at least one magnetic object; and
an inductive coil, disposed corresponding to the at least one magnetic object and electrically connected to the signal transmitting device, wherein the inductive coil moves with respect to the at least one magnetic object, the electrical energy is generated.

6. The system of claim 1, wherein the signal transmitting device is a signal transmitting chip.

7. The system of claim 5, wherein the at least one magnetic object is disposed on a pushing door, and the inductive coil is disposed on a door knob.

8. The system of claim 5, wherein the inductive coil is disposed on an outer frame of a fan, and the magnetic object is disposed on a fan blade of the fan.

9. The system of claim 5, wherein the magnetic object is disposed on a casing of a toilet, and the inductive coil is disposed on a handle of a flushing switch.

10. The system of claim 5, wherein the inductive coil is disposed on a main body of a gas stove, and the magnetic object is disposed on a rotary switch.

11. The system of claim 5, wherein the magnetic object is disposed on an external side of a turbine blade, and the inductive coil is disposed on external side of a water pipe of a water faucet, and wherein the turbine blade is disposed in the water pipe of the water faucet.

12. The system of claim 5, wherein the magnetic object is disposed on a door frame of a window, and the inductive coil is disposed on the window.

13. The system of claim 5, wherein the inductive coil is disposed in a main body of a toothbrush or coated on an external part of the main body, and the magnetic object is disposed in the main body of the toothbrush, and wherein the magnetic object moves in the main body of the toothbrush.

14. The system of claim 5, wherein the magnetic object is disposed on a main body of a mesh gear of a drawer, and the mesh gear is meshed with a sliding rail of the drawer.

15. The system of claim 5, wherein the notification signal is transmitted to a receiving device.

16. The system of claim 1, wherein the energy conversion device comprises:
an electromagnetic energy conversion device, disposed close to the a varying magnetic field generator object, wherein when a user uses the a varying magnetic field generator object, the electromagnetic energy conversion device generate an electrical energy.

17. The system of claim 16, wherein the electromagnetic energy conversion device includes an inductive coil, configured to sense a change of a magnetic field of the varying magnetic field generator object.

18. The system of claim 1, wherein the energy conversion device comprises:
a thermoelectric power generating device, disposed on a heat generating object, wherein when a user uses the heat generating object, the thermoelectric power generating device generate an electrical energy.

19. The system of claim 1, wherein the notification signal is used to determine how long the user uses the object.
